(19) United States
(12) Patent Application Publication
(10) Pub. No.: US 2007/0027479 A1
(43) Pub. Date: Feb. 1, 2007

(54) FEEDING PACIFIER WITH REMOVABLE FLUID SOURCE

(75) Inventor: Ron Carter, Matthews, NC (US)

Correspondence Address: TILLMAN WRIGHT, PLLC, PO BOX 471581, CHARLOTTE, NC, 28247, US

(73) Assignee: REVOLUTIONARY CONCEPTS, INC., Matthews, NC (US)

(21) Appl. No.: 11/461,470

(22) Filed: Aug. 1, 2006

Related U.S. Application Data
(60) Provisional application No. 60/704,470, filed on Aug. 1, 2005.

(51) Int. Cl. A61J 17/00

(52) U.S. Cl. 606/234

(57) ABSTRACT

An apparatus for feeding a child includes a pacifier having a mouthpiece and a shield. A fluid source is releasably coupled to the pacifier such that the fluid source is completely supported and retained by the pacifier. The consumable fluid is dispensed from the fluid source through the mouthpiece of the pacifier to the child.

### I. CROSS-REFERENCE TO RELATED APPLICATION

The present application is a nonprovisional of, and claims priority under 35 U.S.C. § 119(e) to, Carter U.S. Provisional Patent Application No. 60/704,470 filed Aug. 1, 2005. The entire disclosure of this patent application is hereby incorporated herein by reference.

### II. COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### III. BACKGROUND OF THE INVENTION

Babies and young children frequently accompany parents on outings and often desire food and beverages to satisfy their physical needs, to occupy travel time, and to serve non-physical needs with regard to emotional comfort and feelings of security. Thus, feeding bottles are available, although typical examples require support by the hand of an adult while a child feeds, especially with regard to infants. Pacifiers are available that, to some extent, address feeding instincts of a child and invoke feelings of security and comfort. Pacifiers particularly address travel situations and moments when parents are too busy to support a feeding bottle. However, as many parents know, there are times when a child desires feeding for physical or non-physical reasons and will not be satisfied by a pacifier.

Therefore, a need exists for a feeding system that provides benefits and conveniences, while obviating shortfalls, of both bottles and pacifiers.

### IV. SUMMARY OF THE INVENTION

The present invention includes many aspects and features. In a first aspect of the invention, an apparatus for feeding a child comprises a pacifier including a mouthpiece and a shield and a fluid source adapted to releasably couple to the pacifier such that the fluid source is completely supported and retained by the pacifier. Consumable fluid is dispensable from the fluid source through the mouthpiece of the pacifier.

In a feature of this aspect, the pacifier further comprises a nipple and a port. The port is adapted to releasably couple to the fluid source such that the fluid is dispensable from the fluid source through the nipple. In another feature of this aspect, the fluid source comprises a container having a sealed thin membrane. The thin membrane is ruptured upon coupling of the fluid source to the pacifier.

In an additional feature of this aspect, the fluid source comprises a cartridge including a generally cylindrical body having a port disposed therein. In accordance with this feature, the cartridge has a fluid displacement article disposed therein, with the fluid displacement article has a higher mass density than the fluid. With further regard to this feature, the cartridge further includes a pair of gaskets spaced on opposing sides of the port for engagement with the fluid displacement article.

In another feature of this aspect, the fluid source comprises a cartridge having a cylindrical port. In furtherance of this feature, the cylindrical cartridge port is threaded for releasable coupling with a threaded cylindrical port of the pacifier. With regard to this feature, the pacifier includes a cylindrical port with an upturned mouth for receiving the cylindrical port of the cartridge.

In yet another feature, the fluid source comprises a reservoir connected to a port by way of a tube, wherein the port may be releasably coupled to the pacifier. In still yet another feature, the pacifier comprises a valve, wherein the valve is sealed prior to the fluid source coupling to the pacifier, and, wherein the valve is unsealed upon coupling of the fluid source to the pacifier.

In another aspect of the invention, a fluid source assembly comprises a package and a plurality of disposable, single use containers disposed within the package. Each container contains consumable fluid and each container is adapted to couple to a mouthpiece of a pacifier for dispensing of the consumable fluid from the container through the mouthpiece.

In a feature of this aspect, each container contains the same consumable fluid. With further regard to this feature, the same consumable fluid consists of baby feeding formula, milk, juice, or water. In another feature of this aspect, a first of the containers contains a first consumable fluid, and a second of the containers contains a second consumable fluid. The first consumable fluid is different from the second consumable fluid. In yet another feature, the fluid source assembly defines a variety pack of beverages for a child. In an additional feature, a pacifier includes the mouthpiece, and the pacifier is not disposed within the package.

In an additional aspect of the invention, a method for dispensing a consumable fluid into a mouth of a child comprises the steps of (a) coupling a container to a pacifier with the container containing a consumable fluid and (b) disposing a mouthpiece of the pacifier into the mouth of a child.

In a feature of this aspect, the step (a) is performed prior to performance of the step (b). In a further feature of this aspect, the step (b) is performed prior to performance of the step (a).

In another aspect of the invention, a method for dispensing a consumable fluid into a mouth of a child comprises the steps of coupling a first container into engagement with a pacifier with the container containing a first consumable fluid; disposing a mouthpiece of the pacifier into the mouth of a child, thereby facilitating dispensation of the first consumable fluid into the mouth of the child; decoupling the first container from the pacifier without removing the mouthpiece of the pacifier from the mouth of the child; and coupling a second container into engagement with the pacifier without removing the mouthpiece of the pacifier from the mouth of the child, thereby facilitating dispensation of the second consumable fluid into the mouth of the child.

In addition to the aforementioned aspects and features of the present invention, it should be noted that the present invention further includes the various possible combinations of such aspects and features.

### V. BRIEF DESCRIPTION OF THE DRAWINGS

One or more preferred embodiments of the present invention now will be described in detail with reference to the accompanying drawings which are briefly described below, wherein the same elements are referred to with the same reference numerals, and wherein various elements are not necessarily shown in conformance to any particular absolute or relative scale.

FIG. 1A is an elevational side view of a feeding pacifier according to a preferred embodiment of the present invention.

FIG. 1B is an elevational end view of the feeding pacifier of FIG. 1A.

FIG. 2A is an elevational view of a fluid cartridge according to a preferred embodiment of the invention, viewed along a longitudinal axis of the cartridge.

FIG. 2B is an elevational view of the fluid cartridge of FIG. 2A, viewed transversely to the longitudinal axis thereof.

FIG. 3A is an elevational side view of the feeding pacifier of FIG. 1A engaged with the fluid cartridge of FIG. 2A.

FIG. 3B is an elevational end view of the feeding pacifier of FIG. 1B engaged with the fluid cartridge of FIG. 2B.

FIG. 4 is a side view of a fluid cartridge according to an alternative preferred embodiment of the invention, shown with the longitudinal axis thereof rotated from a horizontal orientation.

FIG. 5 is a side view of a fluid cartridge according to another alternative preferred embodiment of the invention, also shown with the longitudinal axis thereof rotated from a horizontal orientation.

FIG. 6 is a side view of a fluid cartridge according to yet another alternative preferred embodiment of the invention, shown with the longitudinal axis thereof rotated from a horizontal orientation.

FIG. 7 is a plan view of a package of fluid cartridges according to a preferred embodiment of the invention.

FIG. 8 is a plan view of a fluid source according to the invention, shown with the feeding pacifier of FIG. 1A.

FIG. 9A is an elevational side view of another feeding pacifier and another fluid reservoir cartridge, each according to another embodiment of the invention.

FIG. 9B is an elevational side view of the feeding pacifier of FIG. 9A engaged with the fluid reservoir cartridge.

FIG. 10 is a partial cross-sectional view of a sealed valve defined by a port of a feeding pacifier according to a preferred embodiment of the invention.

FIG. 11 is a partial cross sectional view of an unsealed valve defined by a port of a feeding pacifier engaged with a port of a fluid reservoir cartridge according to the invention.

FIG. 12 is an elevational side view of yet another feeding pacifier and yet another fluid reservoir cartridge, each according to yet another embodiment of the invention.

FIG. 13A is an elevational view of the fluid reservoir cartridge according to a preferred embodiment of the invention, shown with a cap disposed on the cartridge.

FIG. 13B is another elevational view of the fluid reservoir cartridge of FIG. 13A, shown with the cap removed from the cartridge.

FIG. 14A is a view of the feeding pacifier of FIG. 12 in the process of being engaged with the fluid reservoir cartridge of FIG. 13B.

FIG. 14B is a view of the feeding pacifier of FIG. 12 engaged with the fluid reservoir cartridge of FIG. 13B.

FIG. 15 is a plan view of a package, according to a preferred embodiment of the invention, of fluid cartridges according to the embodiment of FIG. 13A.

### VI. DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein-as understood by the Ordinary Artisan based on the contextual use of such term-differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

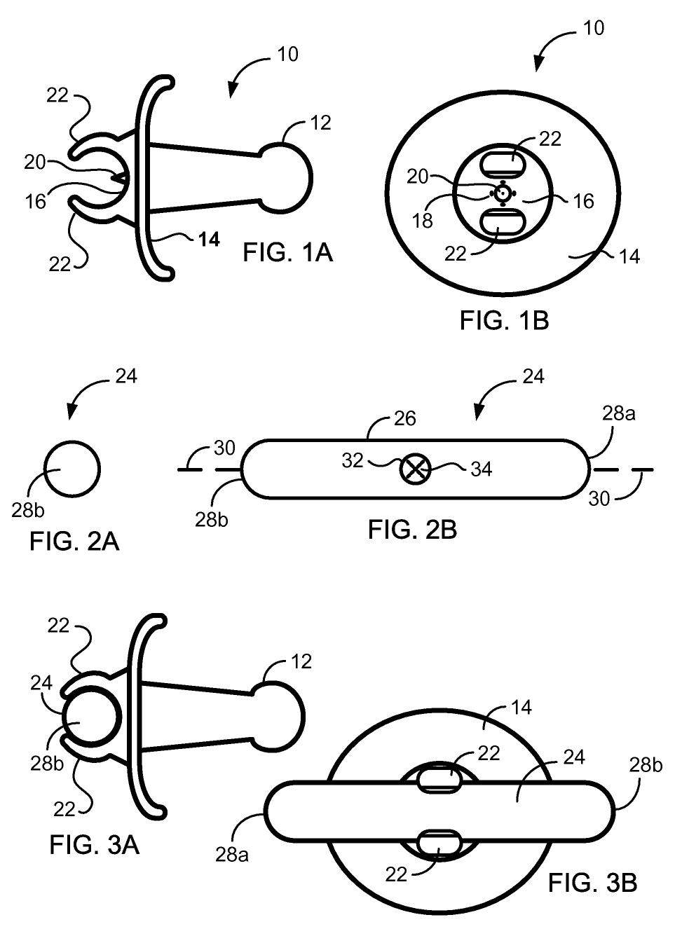

Turning now to FIGS. 1A-1B, in a preferred embodiment of the invention, a feeding pacifier 10 includes a nipple 12, a shield 14, and a port 16. The nipple 12 is for mouthing and sucking by a child as is customary with regard to conventional pacifiers and baby bottles. The shield 14 prevents the nipple 12 from being drawn too far into the mouth of a child and thereby prevents choking and suffocation.

The feeding pacifier 10 receives fluid, such as feeding formula, through the port 16 and dispenses the fluid through the nipple 12 when a child sucks therefrom. In the present embodiment, the port 16 includes a number of holes 18 surrounding a punch 20. The punch 20 is for piercing a fluid source, or manipulating a valve thereof, to permit fluid to flow from the source, through the holes 18, into the interior of the nipple 12, and outward from the nipple for feeding of a child.

The port 16 of the feeding pacifier 10 is constructed to engage and releasably retain a fluid source. In the illustrated embodiment, opposing fingers 22 partially surround and grasp a fluid source when the source is received between the fingers 22 and is coupled with the port 16.

An exemplary fluid source for use with the inventive feeding pacifier 10 is shown in FIG. 2A-2B. In this example, the fluid source consists of a fluid cartridge 24. The fluid cartridge 24 comprises a generally cylindrical body 26 having opposing hemispherical ends 28a,28b. A longitudinal axis 30 is defined along the cylindrical body 26 of the fluid cartridge 24. The fluid cartridge 24 is capable of containing therein a fluid and dispensing the fluid through a port 32. The fluid cartridge port 32 is sealed and is fluid impermeable prior to engagement with the port 16 of the feeding pacifier 10. In the illustrated embodiment, the port 30 includes a thin membrane 34 capable of being pierced by the punch 20 of the feeding pacifier 10.

The fluid cartridge 24 and the port 16 of the feeding pacifier 10 may be releasably coupled with one another. More specifically, as shown in FIGS. 3A-3B, during engagement, the fluid cartridge 24 is partially surrounded and releasably grasped by the opposing fingers 22. When coupled, the port 32 of the fluid cartridge 24 is brought into sealing abutment with the port 16 of the feeding pacifier 10. In the illustrated embodiment, the thin membrane 34 of the fluid cartridge 24 is pierced by the punch 20 as the port 32 of the fluid cartridge is brought into sealing abutment with the port 16 of the feeding pacifier.

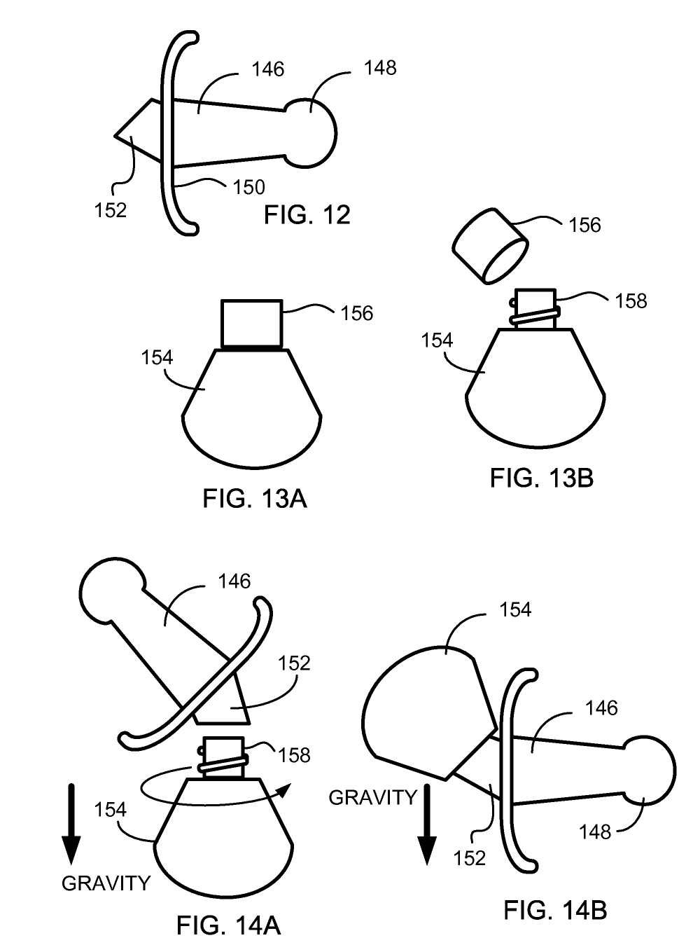

In an alternative preferred embodiment, the fluid cartridge may attach to the feeding pacifier using a threaded connection similar to the connection in the embodiment of FIGS. 12-14B. To the extent that such an alternative preferred embodiment does not require that the feeding pacifier include the fingers 22, such an alternative preferred embodiment is preferred because the omission of the fingers is believed to reduce overall weight of the feeding pacifier when used by a child.

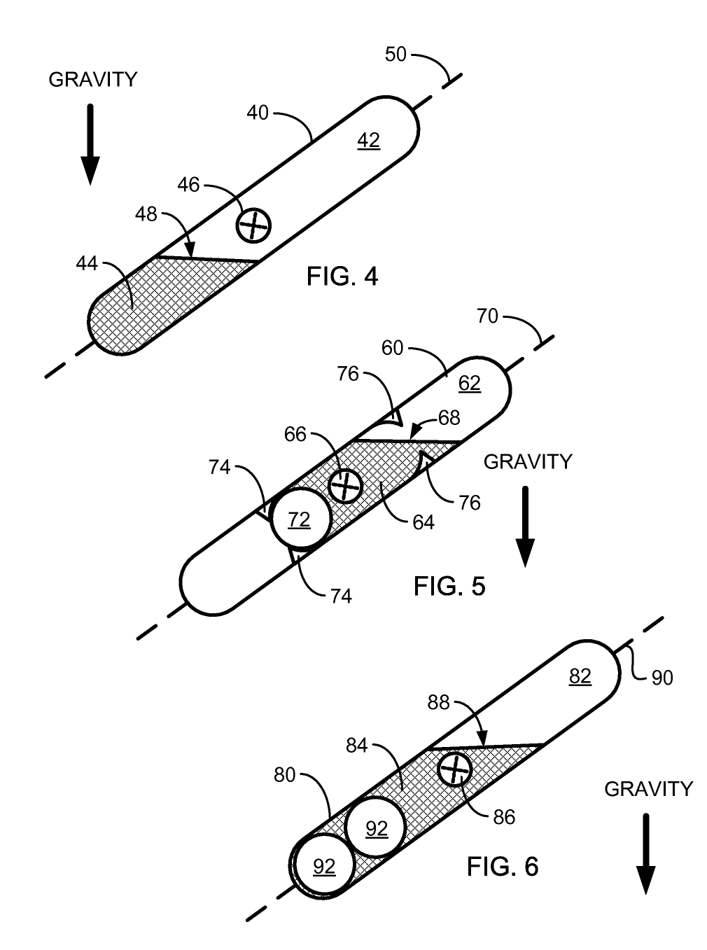

Referring now to FIG. 4, a particular inventive embodiment of a tubular fluid cartridge 40 defines an interior 42 having therein a fluid 44 that is generally free to flow about within the interior under the force of gravity. The fluid cartridge 40 is capable of engagement with the feeding pacifier 10 as shown, for example, in FIGS. 3A-3B, with reference to the fluid cartridge 24. As the fluid 44 is drawn from the cartridge through the port 46, the volume of the remaining fluid is reduced until the level 48 of the fluid falls below the port. Particularly in a situation wherein the disposition of the longitudinal axis 50 defined by the cartridge 40 is oriented to allow fluid to collect below the port 46, a significant volume of the fluid may be unavailable for feeding.

Other inventive embodiments of fluid cartridges include structures aimed at minimizing the collection of fluid below a port. For example, in FIG. 5 a fluid cartridge 60 defines an interior 62 having therein a fluid 64 that is generally free to flow about within the interior under the force of gravity. The fluid cartridge 60 may be engaged with the feeding pacifier 10. As the fluid 64 is drawn from the cartridge through the port 66, the volume of the remaining fluid is reduced until the level 68 of the fluid falls below the port. A fluid displacement article in the form of a ball 72 is disposed in the interior of the cartridge. The ball is movable under the force of gravity within the interior 62, and, in conjunction with gaskets 74,76 spaced on opposing sides of the port 66, defines respective valves operative to maintain fluid proximal the port to minimize the collection of fluid below the port. The longitudinal axis 70 defined by the cartridge is oriented such that the ball 72, having higher mass density than the fluid 64, has fallen into sealing engagement with the gasket 74 thereby defining a valve above which at least some portion of the fluid 64 is maintained. The level 68 of the fluid 64 is thereby maintained above the port 66, at least to a greater extent in the scenario illustrated in FIG. 5 than in the scenario illustrated in FIG. 4.

Another example of an inventive embodiment of a fluid cartridge is shown in FIG. 6. The fluid cartridge 80 defines an interior 82 having therein a fluid 84 that is generally free to flow about within the interior under the force of gravity. The fluid cartridge 80 is capable of engagement with the feeding pacifier 10. As the fluid 84 is drawn from the cartridge through the port 86, the volume of the remaining fluid is reduced until the level 88 of the fluid falls below the port. One or more fluid displacement articles 92 movable under the force of gravity within the interior 82 displace some portion of the volume of the fluid that might otherwise collect below the port 86. The longitudinal axis 90 is oriented such that one or more articles 92, having higher mass density than the fluid 84, fall below the port 86 thereby maintaining the level 88 above the port 86, at least to a greater extent in the scenario illustrated in FIG. 6 than in the scenario illustrated in FIG. 4.

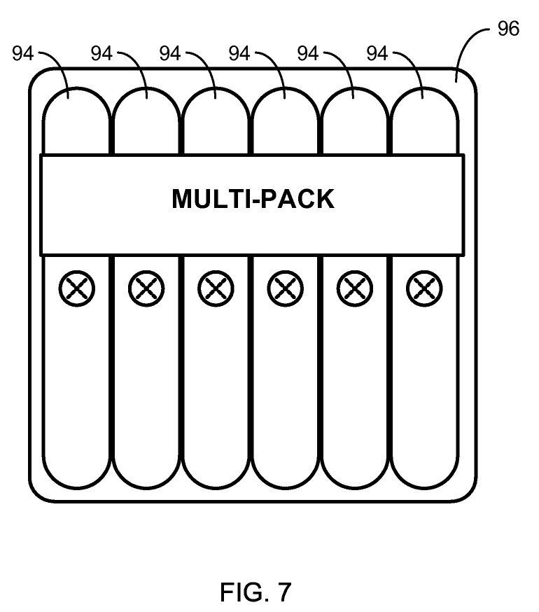

Optionally, multiple fluid cartridges 94 are made available to consumers in a package 96 according to an aspect of the invention as shown in FIG. 7. The package 96 is optionally a blister package and is optionally refrigerated or non-refrigerated according to the fluid contents of the cartridges 94 and perishable properties thereof. Each of the fluid cartridges in a package may contain the same fluid. For example, a package for young babies may contain cartridges of feeding formula. The fluid cartridges in a package may also contain different fluids. For example, a variety package for older babies may contain cartridges having milk, juice and water, or some other variation of available fluids. The fluid cartridges will generally contain either feeding formula, milk, juice or water.

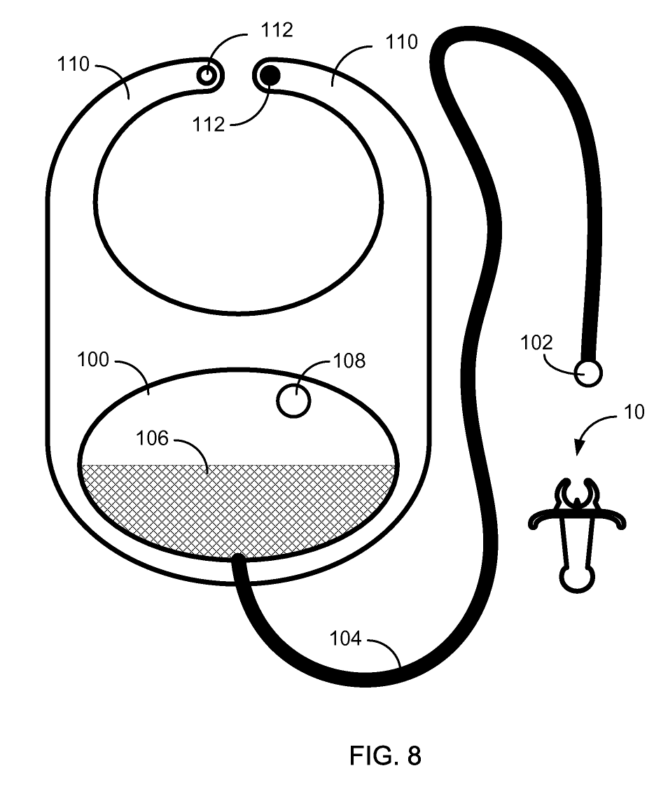

Another exemplary fluid source for use with the inventive feeding pacifier 10 is shown in FIG. 8. In this embodiment, the fluid source comprises a reservoir 100 connected to a port 102 by way of a tube 104. Fluid 106 within the reservoir 100 flows through the tube 104 to the port 102. The port 102 is capable of engagement with the feeding pacifier 10 for delivering the fluid 106 of the reservoir 100 to the feeding pacifier through the tube 104. Optionally, the fluid reservoir includes a refill port 108. Furthermore, the fluid reservoir optionally includes support straps having fasteners 112 for supporting the reservoir. For example, the reservoir 100 may be worn as a garment, such as a bib, about the neck of a feeding child, or may be worn or supported by an adult feeding a child.

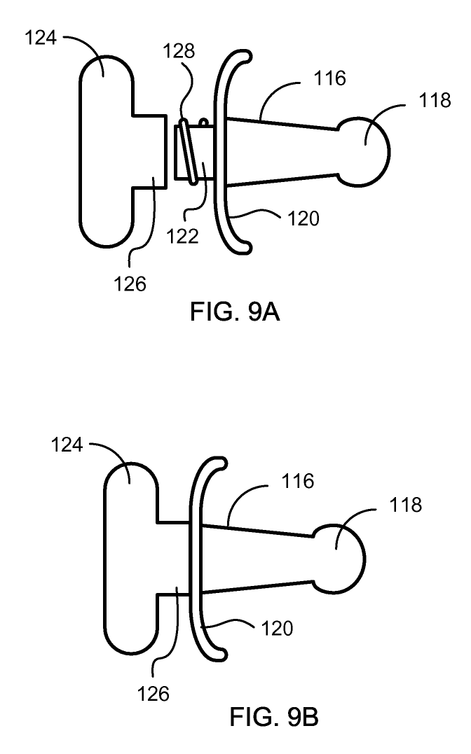

Turning now to FIGS. 9A-9B, in another embodiment of the invention, a feeding pacifier 116 includes a nipple 118, a shield 120, and a port 122. The nipple 118 is for mouthing and sucking by a child as is customary with regard to conventional pacifiers and baby bottles. The shield 120 prevents the nipple 118 from being drawn too far into the mouth of a child and thereby prevents choking and suffocation. The feeding pacifier 116 receives fluid such as feeding formula through the port 122 and dispenses the fluid through the nipple 118 when a child feeds therefrom. In an exemplary embodiment, a fluid reservoir cartridge 124 is adapted to engage with the feeding pacifier 116. More particularly, a port 126 of the cartridge is adapted to engage with the port 122 of the feeding pacifier.

In this embodiment, the port 122 comprises a cylindrical port having external threads 128, and the port 126 comprises a cylindrical port having internal threads (not shown) for turning engagement with the threads 128. The port 126 receives the port 122 as shown in FIG. 9B, and the feeding pacifier 116 and fluid reservoir cartridge 124 are engaged by turning of the cartridge relative to the pacifier. The cartridge and pacifier are preferably engaged by one full relative rotation. The fluid reservoir cartridge 124 is optionally collapsible to facilitate drawing out of the fluid within the reservoir without creation of a vacuum within the cartridge that would otherwise impede feeding.

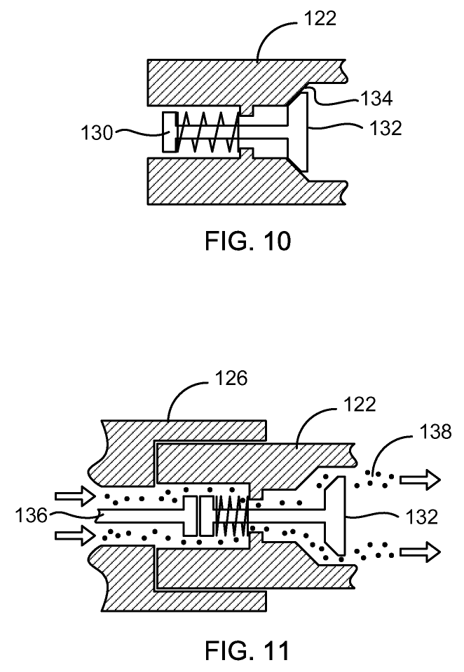

As shown in FIG. 10, a valve may be defined within the port 122 of the feeding pacifier 116 by a valve stem 130 attached to a stopper 132. The stopper is biased by a coil spring into sealing engagement with a gasket 134 defined by the port 122. As shown in FIG. 11, when the port 126 of the fluid reservoir cartridge is engaged with the port 122 of the feeding pacifier, a push-rod 136 of the port 126 presses the valve stem such that the stopper 132 is displaced from the gasket to allow fluid 138 to flow through the port 122. A benefit provided by such a valve is that the feeding pacifier 116 may be used as a conventional pacifier, without a fluid reservoir cartridge attached thereto, without a child drawing air through the nipple 118 as the child sucks thereon.

Turning now to FIGS. 12-14B, in yet another embodiment of the invention, a feeding pacifier 146 includes a nipple 148, a shield 150, and a port 152. The nipple 148 is for mouthing and sucking by a child as is customary with regard to conventional pacifiers and baby bottles. The shield 150 prevents the nipple 148 from being drawn too far into the mouth of a child and thereby prevents choking and suffocation. The feeding pacifier 146 receives fluid such as feeding formula through the port 152 and dispenses the fluid through the nipple 148 when a child feeds therefrom.

A fluid reservoir cartridge 154 is adapted to engage with the feeding pacifier 146 by engagement of a port 158 of the cartridge with the port 152 of the feeding pacifier. The fluid reservoir cartridge 154 includes a removable cap 156 for maintaining the port 158 in a sanitary condition and for retaining fluid within the cartridge. The port 158 optionally includes a breakable or removable seal such as a foil closure (not shown) or a plasticized closure that is removed by hand or is ruptured when the cartridge 154 is engaged with the feeding pacifier 146.

In this illustrated example, the port 152 of the feeding pacifier 146 comprises an upturned mouth for receiving the port 158 of the cartridge 154. As shown in FIG. 14A, the cartridge 154 is engaged with the feeding pacifier 146 by turning the cartridge relative to the pacifier thereby engaging respective threads. Optionally, the cartridge is maintained in an upright disposition until full engagement is achieved to prevent spilling of the fluid within the cartridge. Once full engagement is achieved, as shown in FIG. 14B, the feeding pacifier 146 is disposed with the nipple 148 in the mouth of a child (not shown) such that the cartridge 154 is generally maintained upward from the port 152 of the pacifier so that the full contents of the cartridge are consumed without the level thereof falling below the port 152.

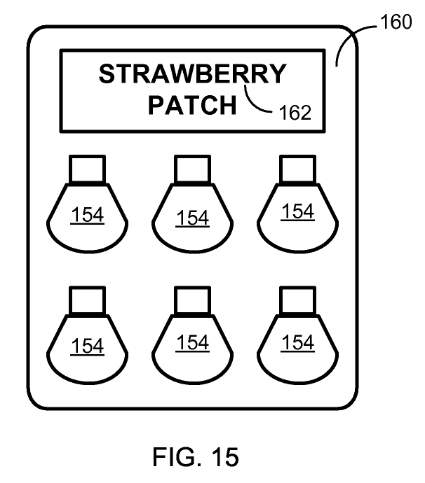

Optionally, multiple fluid cartridges 154 are made available to consumers in a package 160 according to an aspect of the invention as shown in FIG. 15. The package 160 is optionally a blister package and is optionally refrigerated or non-refrigerated according to the fluid contents of the cartridges 154 and perishable properties thereof. Graphical indicia 162 are optionally included on the package 160 for encouraging sales and providing information. For example, insofar as the fluid cartridges 154 are shaped somewhat like strawberries, graphical indicia 162 may relate the package 160 to a strawberry patch thereby amusing the consumer and enticing purchases of the package.

In use, an adult may couple the fluid source to the feeding pacifier and then place the feeding pacifier in a child's mouth or the adult may place the feeding pacifier in the child's mouth and then couple the fluid source to the pacifier. The circumstances surrounding a child's use will often determine the method of use that an adult chooses. Further, in the event a child drinks all of the fluid in a first fluid source, a parent or other adult may decouple the empty first fluid source and couple a second fluid source to the feeding pacifier. Because of the releasable coupling design of the feeding pacifier, it is possible for a parent to make this switch soon after the first fluid source becomes empty so that a child is never aware of the first fluid source being empty. A parent that has experienced a hungry or agitated child running out of a desired fluid will appreciate the advantage of a quick switch from one fluid source to another.

The feeding pacifier of the present invention is ideal because it combines the benefits of a conventional bottle with those of a pacifier. It provides the soothing that is typically associated with a pacifier and also provides a means for feeding a hungry or agitated child. Further, the feeding pacifier provides a way to feed a child in those instances when it is not convenient or not possible to hold a bottle for the child.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. An apparatus for feeding a child, the apparatus comprising:
(a) a pacifier including a mouthpiece and a shield; and
(b) a fluid source adapted to releasably couple to said pacifier such that said fluid source is completely supported and retained by said pacifier;
(c) wherein consumable fluid is dispensable from said fluid source through said mouthpiece of said pacifier.

2. The apparatus of claim 1, said pacifier further comprising a nipple and a port, wherein said port is adapted to releasably couple to said fluid source such that said fluid is dispensable from said fluid source through said nipple.

3. The apparatus of claim 1, said fluid source comprising a container having a sealed thin membrane, wherein said thin membrane is ruptured upon coupling of said fluid source to said pacifier.

4. The apparatus of claim 1, said fluid source comprising a cartridge including a generally cylindrical body having a port disposed therein.

5. The apparatus of claim 4, said cartridge having a fluid displacement article disposed therein, said fluid displacement article having a higher mass density than the fluid.

6. The apparatus of claim 5, said cartridge further including a pair of gaskets spaced on opposing sides of said port for engagement with said fluid displacement article.

7. The apparatus of claim 1, said fluid source comprising a cartridge having a cylindrical port.

8. The apparatus of claim 7, said cylindrical cartridge port being threaded for releasable coupling with a threaded cylindrical port of said pacifier.

9. The apparatus of claim 7, said pacifier including a cylindrical port with an upturned mouth for receiving the cylindrical port of the cartridge.

10. The apparatus of claim 1, said fluid source comprising a reservoir connected to a port by way of a tube, wherein said port may be releasably coupled to said pacifier.

11. The apparatus of claim 1, said pacifier comprising a valve, wherein said valve is sealed prior to said fluid source coupling to said pacifier, and, wherein said valve is unsealed upon coupling of said fluid source to said pacifier.

12. A fluid source assembly, comprising:
(a) a package; and
(b) a plurality of disposable, single use containers disposed within said package;
(c) wherein each said container contains consumable fluid and each said container is adapted to couple to a mouthpiece of a pacifier for dispensing of the consumable fluid from said container through said mouthpiece.

13. The fluid source assembly of claim 12, wherein each said container contains the same consumable fluid.

14. The fluid source assembly of claim 13, wherein said same consumable fluid consists of baby feeding formula, milk, juice, or water.

15. The fluid source assembly of claim 12, wherein a first of said containers contains a first consumable fluid, wherein a second of said containers contains a second consumable fluid, and, wherein said first consumable fluid is different from said second consumable fluid.

16. The fluid source assembly of claim 12, said fluid source assembly defining a variety pack of beverages for a child.

17. The fluid source assembly of claim 12, wherein a pacifier includes said mouthpiece, and wherein said pacifier is not disposed within said package.

18. A method for dispensing a consumable fluid into a mouth of a child, the method comprising the steps of:
(a) coupling a container to a pacifier, said container containing a consumable fluid; and
(b) disposing a mouthpiece of the pacifier into the mouth of a child.

19. The method of claim 18, wherein said step (a) is performed prior to performance of said step (b).

20. The method of claim 18, wherein said step (b) is performed prior to performance of said step (a).

21. A method for dispensing a consumable fluid into a mouth of a child, the method comprising the steps of:
(a) coupling a first container into engagement with a pacifier, said container containing a first consumable fluid;
(b) disposing a mouthpiece of the pacifier into the mouth of a child, thereby facilitating dispensation of the first consumable fluid into the mouth of the child;
(c) decoupling the first container from the pacifier without removing the mouthpiece of the pacifier from the mouth of the child; and
(d) coupling a second container into engagement with the pacifier without removing the mouthpiece of the pacifier from the mouth of the child, thereby facilitating dispensation of the second consumable fluid into the mouth of the child.
